(19) United States
(12) Patent Application Publication
(10) Pub. No.: US 2026/0120981 A1
(43) Pub. Date: Apr. 30, 2026

(54) ROTATABLE FIXED STRUCTURE AND ROLLING WHEEL SWITCH STRUCTURE

(71) Applicant: Zhejiang Feihu New Energy Technology Co., Ltd., Jinhua (CN)

(72) Inventors: Feibiao ZHANG, Jinhua (CN); Gan CHEN, Changzhou (CN)

(73) Assignee: Zhejiang Feihu New Energy Technology Co., Ltd., Jinhua (CN)

(21) Appl. No.: 18/981,390

(22) Filed: Dec. 13, 2024

(30) Foreign Application Priority Data
Oct. 24, 2024 (CN) 2024225775272

(51) Int. Cl. H01H 19/14; B25F 5/02

(52) U.S. Cl. CPC H01H 19/14; B25F 5/02; H01H 2019/146

(57) ABSTRACT

The present invention relates to the technical field of electric tools, and discloses a rotatable fixed structure and a rolling wheel switch structure. The rotatable fixed structure and a rolling wheel switch structure includes a rotating support frame and handle shells, where a rotating main body is clamped inside the rotating support frame, and a connecting member, a screw assembly, a rubber plug and a rotating base are arranged on one side of the rotating main body. The structure of the present invention is reasonable. With the screw assembly, the rotating main body can be connected to the rotating support frame, and the whole device can be conveniently rotated manually through the rotating support frame.

### CROSS-REFERENCE TO RELATED APPLICATIONS

The application claims priority to Chinese patent application No. 2024225775272, filed on Oct. 24, 2024, the entire contents of which are incorporated herein by reference.

### TECHNICAL FIELD

The present invention relates to the technical field of electric tools, and in particular, to a rotatable fixed structure and a rolling wheel switch structure.

### BACKGROUND

An electric tool is a mechanized tool, which is powered by a motor or an electromagnet and is operated by driving a working head through a transmission mechanism. The electric tool is usually made into a handheld type and a movable type, has a lightweight structure, and is convenient to carry and use. Compared to a manual tool, the electric tool can improve production efficiency by several times to tens of times, and therefore, the electric tool has been widely used in various fields of national economy and for household use.

However, an existing apparatus lacks a structure capable of conveniently connecting and rotating a rotating main body with a rotating support frame, which easily causes the problem that the whole device cannot be significantly rotated and conveniently carried for movement during use because the rotating main body cannot be conveniently connected to the rotating support frame in a rotatable manner. In addition, a structure capable of reducing the speed after the whole device rotates by a certain angle is lacked, which easily causes the problem that the rotating main body collides with the rotating support frame due to a relatively high speed when the whole device rotates significantly. Therefore, the present invention provides a novel apparatus to solve the problems.

### SUMMARY

### (I) Technical Problems Solved

In view of the shortcomings of the prior art, the present invention provides a rotatable fixed structure and a rolling wheel switch structure to solve the problems that in an existing apparatus, the rotating main body and the rotating support frame cannot be conveniently connected in a rotatable manner, the rotating main body cannot be rotated to a certain angle, and the apparatus cannot decelerate.

### (II) Technical Solution

In order to achieve the purpose mentioned above, the present invention adopts the following technical solution: a rotatable fixed structure and a rolling wheel switch structure, including a rotating support frame and handle shells, where a rotating main body is clamped inside the rotating support frame, a connecting member is arranged on one side of the rotating main body, a screw assembly penetrates through one side of the rotating support frame in a threaded manner, a rubber plug is inserted into the rotating support frame, a rotating base is mounted on a lower surface of the rotating main body in a threaded manner, a butt joint ring is mounted on an upper surface of the rotating main body in a threaded manner, and a connecting rod is mounted on an upper surface of the butt joint ring in a threaded manner; and two handle shells are arranged, each handle shell is fixed by using a bolt through a fixed hole, a rotating screw penetrates through an interior of the handle shell in a threaded manner, a rolling wheel is sleeved on a surface of the rotating screw, and a circuit board is arranged inside the handle shell.

Optionally, the bottom of the rotating support frame can be inserted into a butt joint rod to be connected to the handle shell, two sides of the connecting member are in different shapes, an interior of one side of the connecting member is in a wave fastening shape, and the other side of the connecting member is provided with a circular limiting groove and three insertion holes.

Optionally, a fixed groove is formed in an upper surface of the rotating main body, a fixed buckle is arranged on a lower surface of an interior of the butt joint ring, and the fixed buckle can be inserted into the fixed groove in the upper surface of the rotating main body.

Optionally, a surface of the rotating base is provided with a plurality of resistance grooves, the resistance grooves are in a long strip shape, and a lower surface of the rotating base is configured to a semi-circular protruding shape.

Optionally, a contact rod is arranged inside the butt joint ring, the contact rod is in a tapered shape, a circular fixed rod structure is arranged inside the connecting rod, and the contact rod inside the butt joint ring can be matched with the circular fixed rod structure inside the connecting rod.

Optionally, a lower surface of the handle shell is provided with a battery groove, and a sliding groove corresponding to a battery is arranged inside the lower surface of the handle shell, so as to insert an existing handle battery into the interior of the sliding groove.

Optionally, the two handle shells are arranged and are arranged in opposite directions, a plurality of fixed holes are arranged, and threads are arranged inside the fixed holes, so as to fix the handle shell by using an existing tightening bolt.

Optionally, an upper surface of the rolling wheel is provided with prompt number, a surface of the rolling wheel is provided with a plurality of groups of protruding anti-skid structures, one side of the rolling wheel can be connected to one side of the circuit board, and both sides of the circuit board are provided with circular butt joint holes which can be inserted into the handle shell.

To sum up, the present invention has the following technical effects and advantages:

1. The structure of the present invention is reasonable. With the screw assembly, the rotating main body can be connected to the rotating support frame and the whole device can be conveniently rotated manually through the rotating support frame, and the problem that the whole device cannot be significantly rotated because the whole device cannot be held by hand during rotation is solved. With the rubber plug, the rubber plug can be clamped in a clamping groove formed in the connecting member when the whole device rotates to a certain angle, the effect of deceleration or fixing is achieved, and the problem that the rotating main body collides with the rotating support frame when the whole device rotates to a lower portion due to a relatively high speed when the whole device rotates significantly is solved. With the connecting member, the screw assembly can penetrate through the connecting member, so that the effect of connecting the rotating support frame with the rotating main body is achieved, and the problem of damage to a surface of the rotating main body caused by the screw assembly when the rotating main body is dismounted and mounted from the interior of the rotating support frame for a plurality of times is solved.

2. In the present invention, with the rotating base, the effect of protecting a lower surface of the rotating main body when the lower surface of the rotating main body is exposed when the whole device rotates is achieved, and the problem that after the whole device rotates significantly, the lower surface of the rotating main body is exposed to cause friction and collision with the ground or the wall surface at other positions is solved. With the connecting rod, the effect of mounting the connecting rod on an upper surface of the whole device and increasing the length of the whole device are achieved, the problem that the size of a lower surface of the connecting rod is different from the size of an upper surface of the rotating main body is solved, in addition, the effect of fixing the connecting rod again after the connecting rod is mounted can be achieved by using the contact rod inside the butt joint ring and the fixed rod structure inside the connecting rod, and the problem that the connecting rod is loosened due to the long length when the whole device is used is solved.

3. In the present invention, with the fixed hole, the effects that the handle shell can be conveniently connected and firmness can be increased are achieved; the handle shell can be conveniently dismounted to maintain and check and replace an internal circuit; the problems that after the whole device is used for a long time, the handle shell is loosened or the circuit and device in the handle shell are damaged, but the handle shell cannot be conveniently dismounted are solved; in addition, the problem that the handle shell cannot be rapidly and firmly mounted and used is solved. With the rotating screw, the effects that the rolling wheel can be conveniently fixed and can be conveniently dismounted and used are achieved, and the problem that the rolling wheel cannot be conveniently fixed to the inside of the handle shell and cannot be manually rotated when the whole handle shell is mounted is solved. With the circuit board, the effect that the rotating direction and speed of the whole device can be conveniently adjusted when a person manually rotates the rolling wheel is achieved, and the problem that a user needs to manually rotate the whole device when the whole device rotates is solved.

### BRIEF DESCRIPTION OF THE DRAWINGS

FIG. 1 is a schematic diagram of a rotatable fixed structure according to the present invention;

FIG. 2 is a schematic diagram of a rolling wheel switch structure according to the present invention;

FIG. 3 is a schematic structural diagram of a rotating support frame according to the present invention;

FIG. 4 is a schematic structural diagram of a rotating main body according to the present invention;

FIG. 5 is a schematic structural diagram of a connecting rod according to the present invention;

FIG. 6 is a schematic diagram of a plane structure of a rotating base according to the present invention;

FIG. 7 is a schematic structural diagram of a handle shell according to the present invention; and

FIG. 8 is a schematic structural diagram of a rolling wheel according to the present invention.

In the figures: 1. rotating support frame; 2. rotating main body; 3. connecting member; 4. screw assembly; 5. rubber plug; 6. rotating base; 7. butt joint ring; 8. connecting rod; 9. handle shell; 10. fixed hole; 11. rotating screw; 12. rolling wheel; 13. circuit board.

### DETAILED DESCRIPTION OF THE EMBODIMENTS

The technical solutions in the embodiments of the present invention are clearly and completely described below with reference to the accompanying drawings in the embodiments of the present invention. Apparently, the described embodiments are merely some rather than all of the embodiments of the present invention. Based on the embodiments in the present invention, all other embodiments obtained by those of ordinary skill in the art without making creative labor fall within the scope of protection of the present invention.

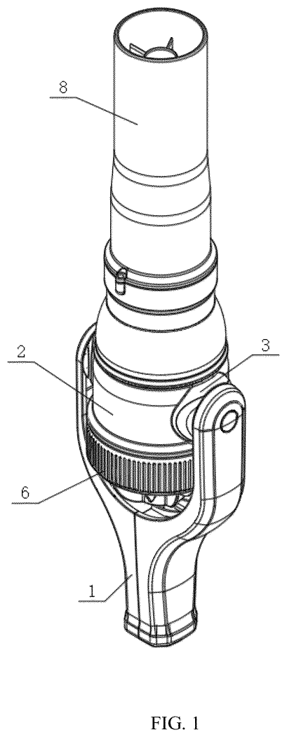

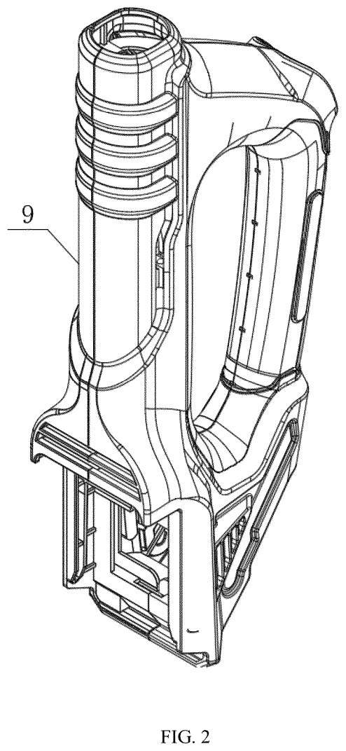

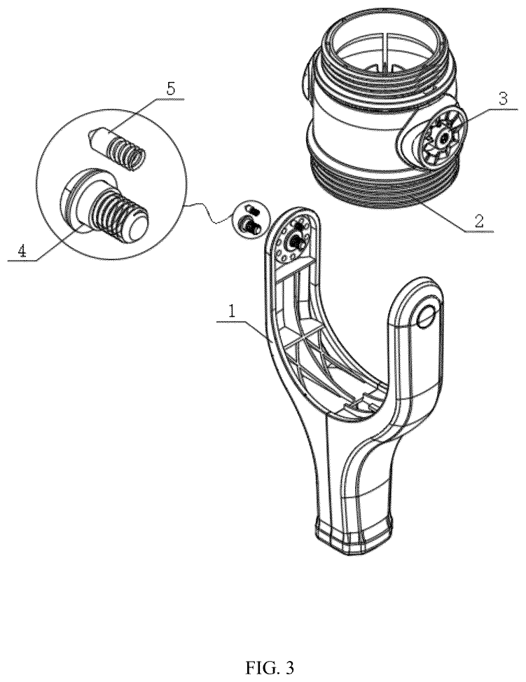

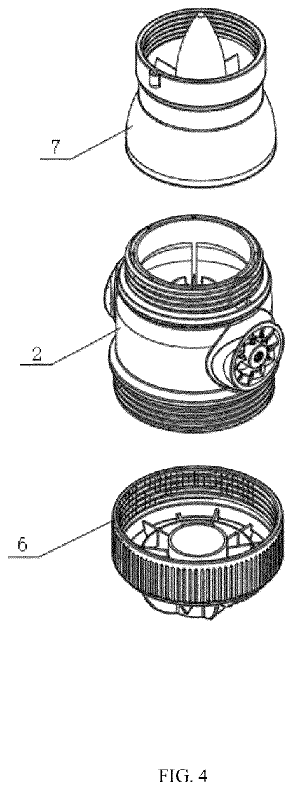

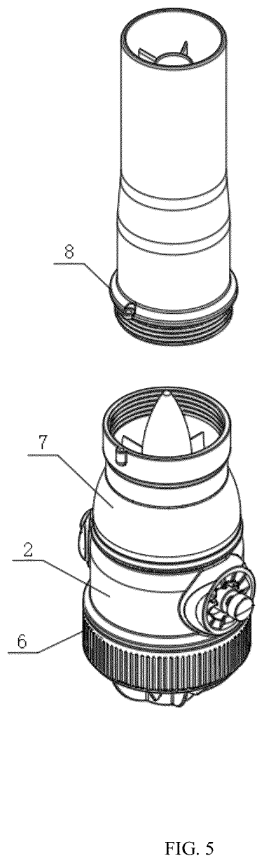

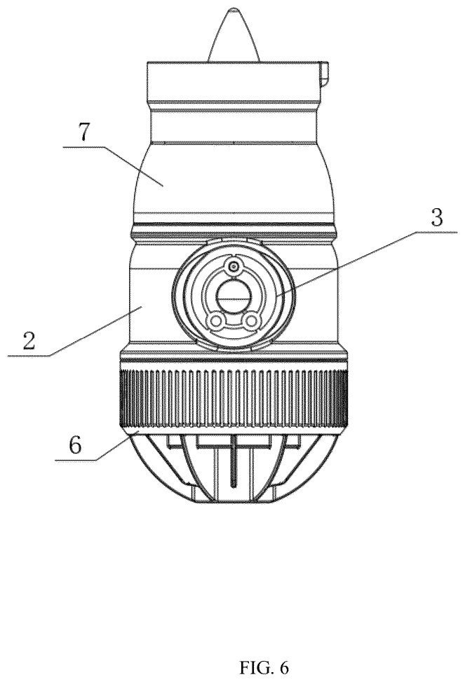

Embodiment: as shown in FIG. 1 to FIG. 8, a rotatable fixed structure and a rolling wheel switch structure includes a rotating support frame 1 and handle shells 9, where the bottom of the rotating support frame 1 can be inserted into a butt joint rod to be connected to the handle shell 9, a rotating main body 2 is clamped inside the rotating support frame 1, a connecting member 3 is arranged on one side of the rotating main body 2, a screw assembly 4 penetrates through one side of the rotating support frame 1 in a threaded manner, a rubber plug 5 is inserted into the rotating support frame 1, a rotating base 6 is mounted on a lower surface of the rotating main body 2 in a threaded manner, a butt joint ring 7 is mounted on an upper surface of the rotating main body 2 in a threaded manner, and a connecting rod 8 is mounted on an upper surface of the butt joint ring 7 in a threaded manner; and two handle shells 9 are arranged, each handle shell 9 is fixed by using a bolt through a fixed hole 10, a rotating screw 11 penetrates through an interior of the handle shell 9 in a threaded manner, a rolling wheel 12 is sleeved on a surface of the rotating screw 11, and a circuit board 13 is arranged inside the handle shell 9.

As a preferred embodiment of this embodiment, as shown in FIG. 1 to FIG. 6, the rotating main body 2 is clamped inside the rotating support frame 1, a fixed groove is formed in an upper surface of the rotating main body 2, the connecting member 3 is arranged on one side of the rotating main body 2, two sides of the connecting member 3 are in different shapes, an interior of one side of the connecting member 3 is in a wave fastening shape, and the other side of the connecting member is provided with a circular limiting groove and three insertion holes. The screw assembly 4 penetrates through one side of the rotating support frame 1 in a threaded manner, the rubber plug 5 is inserted into the rotating support frame 1, and the rotating base 6 is mounted on a lower surface of the rotating main body 2 in a threaded manner. A surface of the rotating base 6 is provided with a plurality of resistance grooves, the resistance grooves are in a long strip shape, and a lower surface of the rotating base 6 is configured to a semi-circular protruding shape. The butt joint ring 7 is mounted on an upper surface of the rotating main body 2 in a threaded manner, a contact rod is arranged inside the butt joint ring 7, and the contact rod is in a tapered shape. A fixed buckle is arranged on a lower surface of an interior of the butt joint ring 7, and the fixed buckle can be inserted into the fixed groove in the upper surface of the rotating main body 2. The connecting rod 8 is mounted on an upper surface of the butt joint ring 7 in a threaded manner, a circular fixed rod structure is arranged inside the connecting rod 8, and the contact rod inside the butt joint ring 7 can be matched with the circular fixed rod structure inside the connecting rod 8. During use, with the screw assembly 4, the rotating main body 2 can be connected to the interior of the rotating support frame 1 and can be rotated, so that the rotating main body 2 can be connected to the rotating support frame 1 and the whole device can be conveniently rotated manually through the rotating support frame 1, and the problem that the whole device cannot be significantly rotated because the whole device cannot be held by hand during rotation is solved. With the rubber plug 5, the rotating main body 2 can be decelerated when the rotating body is rotated to a certain position, so that the rubber plug 5 can be clamped in a clamping groove formed in the connecting member 3 when the whole device rotates to a certain angle, the effect of deceleration or fixing is achieved, and the problem that the rotating main body 2 collides with the rotating support frame 1 when the whole device rotates to a lower portion due to a relatively high speed when the whole device rotates significantly is solved. With the connecting member 3, the screw assembly 4 can be inserted into the interior of the connecting member to protect the surface of the rotating main body 2, and the screw assembly 4 can penetrate through the connecting member 3, so that the effect of connecting the rotating support frame 1 with the rotating main body 2 is achieved, and the problem of damage to a surface of the rotating main body 2 caused by the screw assembly 4 when the rotating main body 2 is dismounted and mounted from the interior of the rotating support frame 1 for a plurality of times is solved. It should be noted that, the two sides of the connecting member 3 are in different shapes, one side of the connecting member 3 is a fixed structure, and the other side is a limiting groove structure. With the rotating base 6, the rotating base 6 can be manually mounted on the lower surface of the rotating main body 2, so that the effect of protecting a lower surface of the rotating main body 2 when the lower surface of the rotating main body 2 is exposed when the whole device rotates is achieved, and the problem that after the whole device rotates significantly, the lower surface of the rotating main body 2 is exposed to cause friction and collision with the ground or the wall surface at other positions is solved. With the butt joint ring 7, the butt joint ring 7 can be manually mounted on the upper surface of the rotating main body 2. With the connecting rod 8, the connecting rod 8 can be manually mounted on the upper surface of the butt joint ring 7, so that the effect of mounting the connecting rod 8 on an upper surface of the whole device and increasing the length of the whole device are achieved, the problem that the size of a lower surface of the connecting rod 8 is different from the size of an upper surface of the rotating main body 2 is solved, in addition, the effect of fixing the connecting rod again after the connecting rod 8 is mounted can be achieved by using the contact rod inside the butt joint ring 7 and the fixed rod structure inside the connecting rod 8, and the problem that the connecting rod 8 is loosened due to the long length when the whole device is used is solved.

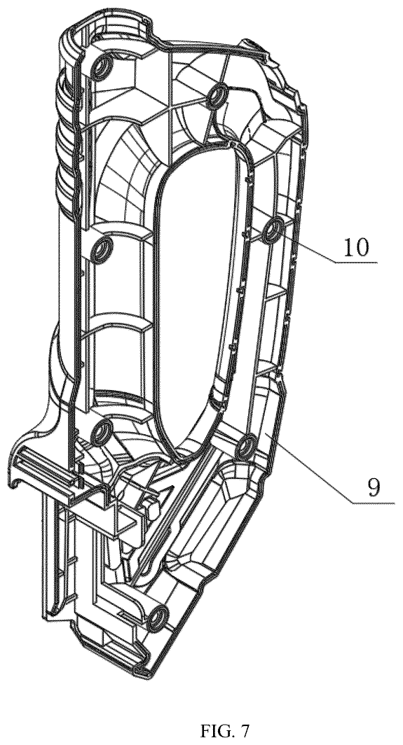

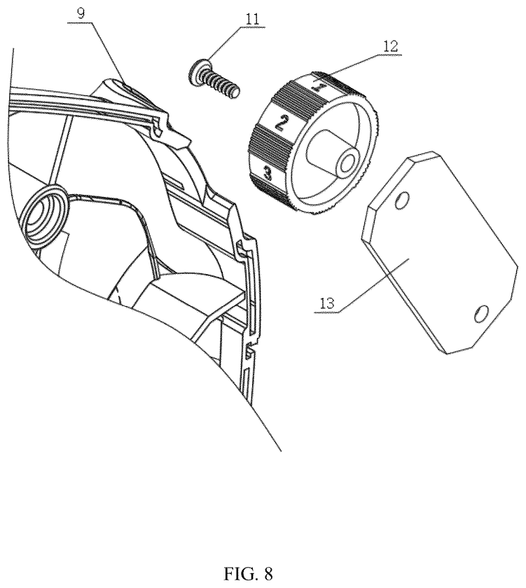

As shown in FIG. 7 and FIG. 8, in this embodiment, two handle shells 9 are arranged, each handle shell 9 is fixed by using a bolt through a fixed hole 10, a rotating screw 11 penetrates through an interior of the handle shell 9 in a threaded manner, a rolling wheel 12 is sleeved on a surface of the rotating screw 11, and a circuit board 13 is arranged inside the handle shell 9. A lower surface of the handle shell 9 is provided with a battery groove, and a sliding groove corresponding to a battery is arranged inside the lower surface of the handle shell 9, so as to insert an existing handle battery into the interior of the sliding groove. The two handle shells 9 are arranged and are arranged in opposite directions, a plurality of fixed holes 10 are arranged, and threads are arranged inside the fixed holes 10, so as to fix the handle shell 9 by using an existing tightening bolt. An upper surface of the rolling wheel 12 is provided with prompt numbers, a surface of the rolling wheel 12 is provided with a plurality of groups of protruding anti-skid structures, one side of the rolling wheel 12 can be connected to one side of the circuit board 13, and both sides of the circuit board 13 are provided with circular butt joint holes which can be inserted into the handle shell 9. During use, with the fixed hole 10, the handle shell 9 can be connected by using an existing bolt, so that the effects that the handle shell 9 can be conveniently connected and firmness can be increased are achieved; the handle shell 9 can be conveniently dismounted to maintain and check and replace an internal circuit; the problems that after the whole device is used for a long time, the handle shell 9 is loosened or the circuit and device in the handle shell 9 are damaged, but the handle shell 9 cannot be conveniently dismounted are solved; in addition, the problem that the handle shell 9 cannot be rapidly and firmly mounted and used is solved. With the rotating screw 11, the rolling wheel 12 can be fixed to the inside of the handle shell 9 and the rolling wheel 12 can be manually rotated on the surface of the rotating screw 11, so that the effects that the rolling wheel 12 can be conveniently fixed and can be conveniently dismounted and used are achieved, and the problem that the rolling wheel 12 cannot be conveniently fixed to the inside of the handle shell 9 and cannot be manually rotated when the whole handle shell 9 is mounted is solved. With the circuit board 13, the circuit board can be mounted inside the handle shell 9, and one side of the circuit board is connected to the rolling wheel 12, and the other side of the circuit board can be connected to a circuit in the handle shell 9, so that the effect that the rotating direction and speed of the whole device can be conveniently adjusted when a person manually rotates the rolling wheel 12 is achieved, and the problem that a user needs to manually rotate the whole device when the whole device rotates is solved. It should be noted that a plurality of placement grooves are formed inside the handle shell 9, and circuits that need to be connected can be placed in the placement grooves for use.

Working principles of the present utility model:

During use, with the screw assembly 4, the rotating main body 2 can be connected to the interior of the rotating support frame 1 and can be rotated, so that the rotating main body 2 can be connected to the rotating support frame 1 and the whole device can be conveniently rotated manually through the rotating support frame 1, and the problem that the whole device cannot be significantly rotated because the whole device cannot be held by hand during rotation is solved. With the rubber plug 5, the rotating main body 2 can be decelerated when the rotating body is rotated to a certain position, so that the rubber plug 5 can be clamped in a clamping groove formed in the connecting member 3 when the whole device rotates to a certain angle, the effect of deceleration or fixing is achieved, and the problem that the rotating main body 2 collides with the rotating support frame 1 when the whole device rotates to a lower portion due to a relatively high speed when the whole device rotates significantly is solved. With the connecting member 3, the screw assembly 4 can be inserted into the interior of the connecting member to protect the surface of the rotating main body 2, and the screw assembly 4 can penetrate through the connecting member 3, so that the effect of connecting the rotating support frame 1 with the rotating main body 2 is achieved, and the problem of damage to a surface of the rotating main body 2 caused by the screw assembly 4 when the rotating main body 2 is dismounted and mounted from the interior of the rotating support frame 1 for a plurality of times is solved. With the rotating base 6, the rotating base 6 can be manually mounted on the lower surface of the rotating main body 2, so that the effect of protecting a lower surface of the rotating main body 2 when the lower surface of the rotating main body 2 is exposed when the whole device rotates is achieved, and the problem that after the whole device rotates significantly, the lower surface of the rotating main body 2 is exposed to cause friction and collision with the ground or the wall surface at other positions is solved. With the butt joint ring 7, the butt joint ring 7 can be manually mounted on the upper surface of the rotating main body 2. With the connecting rod 8, the connecting rod 8 can be manually mounted on the upper surface of the butt joint ring 7, so that the effect of mounting the connecting rod 8 on an upper surface of the whole device and increasing the length of the whole device are achieved, the problem that the size of a lower surface of the connecting rod 8 is different from the size of an upper surface of the rotating main body 2 is solved, in addition, the effect of fixing the connecting rod again after the connecting rod 8 is mounted can be achieved by using the contact rod inside the butt joint ring 7 and the fixed rod structure inside the connecting rod 8, and the problem that the connecting rod 8 is loosened due to the long length when the whole device is used is solved. With the fixed hole 10, the handle shell 9 can be connected by using an existing bolt, so that the effects that the handle shell 9 can be conveniently connected and firmness can be increased are achieved; the handle shell 9 can be conveniently dismounted to maintain and check and replace an internal circuit; the problems that after the whole device is used for a long time, the handle shell 9 is loosened or the circuit and device in the handle shell 9 are damaged, but the handle shell 9 cannot be conveniently dismounted are solved; in addition, the problem that the handle shell 9 cannot be rapidly and firmly mounted and used is solved. With the rotating screw 11, the rolling wheel 12 can be fixed to the inside of the handle shell 9 and the rolling wheel 12 can be manually rotated on the surface of the rotating screw 11, so that the effects that the rolling wheel 12 can be conveniently fixed and can be conveniently dismounted and used are achieved, and the problem that the rolling wheel 12 cannot be conveniently fixed to the inside of the handle shell 9 and cannot be manually rotated when the whole handle shell 9 is mounted is solved. With the circuit board 13, the circuit board can be mounted inside the handle shell 9, and one side of the circuit board is connected to the rolling wheel 12, and the other side of the circuit board can be connected to a circuit in the handle shell 9, so that the effect that the rotating direction and speed of the whole device can be conveniently adjusted when a person manually rotates the rolling wheel 12 is achieved, and the problem that a user needs to manually rotate the whole device when the whole device rotates is solved.

The electrical elements herein are all electrically connected to an external main controller and 220V mains power, and the main controller can be a conventionally known device for control such as a computer.

Finally, it should be noted that the foregoing descriptions are merely preferred embodiments of the present invention, but are not intended to limit the present invention. Although the present invention has been described in detail with reference to the foregoing embodiments, those skilled in the art will readily appreciate that they can make modifications to technical solutions recorded in the embodiments described herein, or make equivalents of some of the features described herein. Any modification, equivalent replacement, or improvement made within the spirit and principle of the present invention should be included in the protection scope of the present invention.

What is claimed is:

1. A rotatable fixed structure and a rolling wheel switch structure, comprising a rotating support frame (1) and handle shells (9), wherein a rotating main body (2) is clamped inside the rotating support frame (1), a connecting member (3) is arranged on one side of the rotating main body (2), a screw assembly (4) penetrates through one side of the rotating support frame (1) in a threaded manner, a rubber plug (5) is inserted into the rotating support frame (1), a rotating base (6) is mounted on a lower surface of the rotating main body (2) in a threaded manner, a butt joint ring (7) is mounted on an upper surface of the rotating main body (2) in a threaded manner, and a connecting rod (8) is mounted on an upper surface of the butt joint ring (7) in a threaded manner; and
two handle shells (9) are arranged, each handle shell (9) is fixed by using a bolt through a fixed hole (10), a rotating screw (11) penetrates through an interior of the handle shell (9) in a threaded manner, a rolling wheel (12) is sleeved on a surface of the rotating screw (11), and a circuit board (13) is arranged inside the handle shell (9).

2. The rotatable fixed structure according to claim 1, wherein the bottom of the rotating support frame (1) can be inserted into a butt joint rod to be connected to the handle shell (9), two sides of the connecting member (3) are in different shapes, an interior of one side of the connecting member (3) is in a wave fastening shape, and the other side of the connecting member is provided with a circular limiting groove and three insertion holes.

3. The rotatable fixed structure according to claim 1, wherein a fixed groove is formed in an upper surface of the rotating main body (2), a fixed buckle is arranged on a lower surface of an interior of the butt joint ring (7), and the fixed buckle can be inserted into the fixed groove in the upper surface of the rotating main body (2).

4. The rotatable fixed structure according to claim 1, wherein a surface of the rotating base (6) is provided with a plurality of resistance grooves, the resistance grooves are in a long strip shape, and a lower surface of the rotating base (6) is configured to a semi-circular protruding shape.

5. The rotatable fixed structure according to claim 1, wherein a contact rod is arranged inside the butt joint ring (7), the contact rod is in a tapered shape, a circular fixed rod structure is arranged inside the connecting rod (8), and the contact rod inside the butt joint ring (7) can be matched with the circular fixed rod structure inside the connecting rod (8).

6. The rotatable fixed structure according to claim 1, wherein a lower surface of the handle shell (9) is provided with a battery groove, and a sliding groove corresponding to a battery is arranged inside the lower surface of the handle shell (9), so as to insert an existing handle battery into the interior of the sliding groove.

7. The rolling wheel switch structure according to claim 1, wherein the two handle shells (9) are arranged and are arranged in opposite directions, a plurality of fixed holes (10) are arranged, and threads are arranged inside the fixed holes (10), so as to fix the handle shell (9) by using an existing tightening bolt.

8. The rolling wheel switch structure according to claim 1, wherein an upper surface of the rolling wheel (12) is provided with prompt numbers, a surface of the rolling wheel (12) is provided with a plurality of groups of protruding anti-skid structures, one side of the rolling wheel (12) can be connected to one side of the circuit board (13), and both sides of the circuit board (13) are provided with circular butt joint holes which can be inserted into the handle shell (9).
